(19) United States
(12) Patent Application Publication
(10) Pub. No.: US 2005/0132977 A1
(43) Pub. Date: Jun. 23, 2005

(54) Treadmill for horses

(76) Inventor: Siegfried Mitzel, Harburg-Grosssorheim (DE)

Correspondence Address: EDELL, SHAPIRO, FINNAN & LYTLE, LLC, 1901 RESEARCH BOULEVARD, SUITE 400, ROCKVILLE, MD, 20850, US

(21) Appl. No.: 10/962,748

(22) Filed: Oct. 13, 2004

(30) Foreign Application Priority Data
Oct. 16, 2003 (DE) 203 15944.6

(51) Int. Cl. A01D 15/00

(52) U.S. Cl. 119/700

(57) ABSTRACT

A treadmill for horses includes a basic structure with a frame. The frame includes two parallel longitudinal beams which are spaced from each other by more than the width of the animal and comprise supports for an at least three-ply, continuous support covering. The support covering includes from top to bottom a sheet steel plate, a damping plate and a sliding plate. The upper strand of an endless belt runs on the latter. Its service life is extended to a considerable extent if at least one lubricant line each opens above the lower strand of the belt on either side of the longitudinal central line of the belt, so that the upper side of the lower strand is supplied with lubricant, thus forming a lubricating film between the lower side of the upper strand and the sliding plate.

The invention relates to a treadmill for horses, consisting of a basic structure in which a frame is held which comprises two parallel longitudinal beams which are spaced from one another by more than the width of the animal and which comprises rests for an at least three-ply, continuous support covering that, from top to bottom, comprises a sheet steel plate, a damping plate made of bound rubber or plastic granulate, and a sliding plate made of plastic-coated steel or plastic on which runs the upper strand of an endless belt that is guided via a motor-driven deflection roller at the one end of the frame and a freely rotating deflection roller at the other end of the frame.

Such a training device is known from DE 295 07 696 U1. In contrast to the older state of the art in which the upper strand of the belt was supported over its entire length by freely rotating rollers, the support covering of the training device according to DE 295 07 696 U1 offers the advantage of an even compliance, which comes close to that of natural soil (grass or wood) and which can be varied by a suitable choice of the thickness and structure, and especially of the damping plate. It was noticed, however, that even when a material such as PTFE (Teflon) is chosen as a material for the sliding plate, which material has a low coefficient of friction in its pairing with the material of the belt, the more or less punctiform loading by the treading hooves of the horse lead to a relatively great amount of wear and tear which is linked to heat development, which thus has a disadvantageous effect on the service life of the belt. Moreover, the evenness of the run of the belt can be impaired by parts rubbed off between the lower side of the upper strand of the belt and the sliding plate which is situated underneath.

The invention is based on the object of considerably increasing the service life of the belt in particular in a treadmill of the kind mentioned above.

This object is achieved in accordance with the invention in such a way that on either side of the longitudinal center line of the belt one lubricant line each opens above the lower strand of the belt. A suitable lubricant can be applied via said lubricant lines onto the upper side of the returning lower strand of the belt, so that a lubricant layer is formed between the lower side of the upper strand of the belt and the sliding plate underneath. The latter has a strong friction-reducing effect, thus not only increasing the service life of the belt and the sliding plate, but also ensuring an even run of the belt and a reduction of the power consumption of the drive motor. As a result of the lower friction between the lower side of the upper strand of the belt and the sliding plate which is caused by the lubrication, there is also less frictional heat below the regions of the belt on which the horse treads. Moreover, the lubricant layer guides and conveys a part of the frictional heat to adjacent, unstressed areas of the belt and the sliding plate.

Two lubricant lines each open on either side of the central line of the belt (claim 2), for a total of four lubricant lines. This ensures an even formation of the lubricant layer over the width of the belt at least in the area of the tread of the horse.

Since the horse will rarely tread on the edges of the belt, it is appropriate to provide more lubricant in the middle region of the belt than close to the edges of the belt. This can be best achieved in such a way that the openings of the lubricant lines have a distance of less than a quarter of the width of the belt from the longitudinal central line (claim 3).

Preferably, the lubricant lines are connected with a common lubricant container (claim 4).

Although it is possible that principally the lubricant could be supplied from the container to the lubricant lines (and in the end to the lower side of the upper strand of the belt) as required in an uneven manner by hand, it is more convenient for the user, and also more even, to provide an automatic lubrication, which can be achieved in such a way that a dosing pump is arranged between the lubricant container and the lubricant lines (claim 5).

Because the belt would run dry after the consumption of the lubricant with the disadvantageous consequences as mentioned above, the lubricant container is appropriately equipped with an alarm sensor which responds to the lubricant level dropping below a minimal filling level (claim 6).

A continuous lubrication is not necessary. It is sufficient if the dosing pump periodically meters approximately one drop of lubricant onto the belt per dosing stroke and lubricant line (claim 7).

In particular, the dosing pump can periodically perform one dosing stroke per lubricant line adjustable in an interval of between 45 and 120 seconds during the running time of the belt (claim 8).

A high-temperature-resistant silicone oil is especially recommended as a lubricant (claim 9). The oil remains sufficiently fluid even at low winter temperatures and retains its full lubricating capabilities at high summer temperatures. A suitable silicone grease can also be considered as an alternative.

Preferably, at least one of the deflection rollers has a crowned profile (claim 10). This not only ensures that the belt does not migrate to the side. The distribution of the lubricant drops first applied in a discrete manner is promoted into a contiguous, even lubricant layer.

For the purpose of forming an even lubricant layer already at the beginning of the upper strand of the belt it is recommended to allow the lubricant lines to open at a distance from the front deflection roller which is at least equal to half the distance of the deflection rollers, i.e., the useful length of the belt (claim 11).

The evening of the compliance of the support covering beneath the upper strand of the belt is also promoted when at least the damping plate and the sliding plate of the support covering rest in a floating manner on the supports (claim 12), since, in the case of fixed clamping of the support covering, constraining forces may arise which cause minor deformations, so that there is increased friction between the upper strand of the belt and the sliding plate at the respective locations.

The drawing shows the treadmill in an exemplary embodiment in a schematic simplified view, wherein:

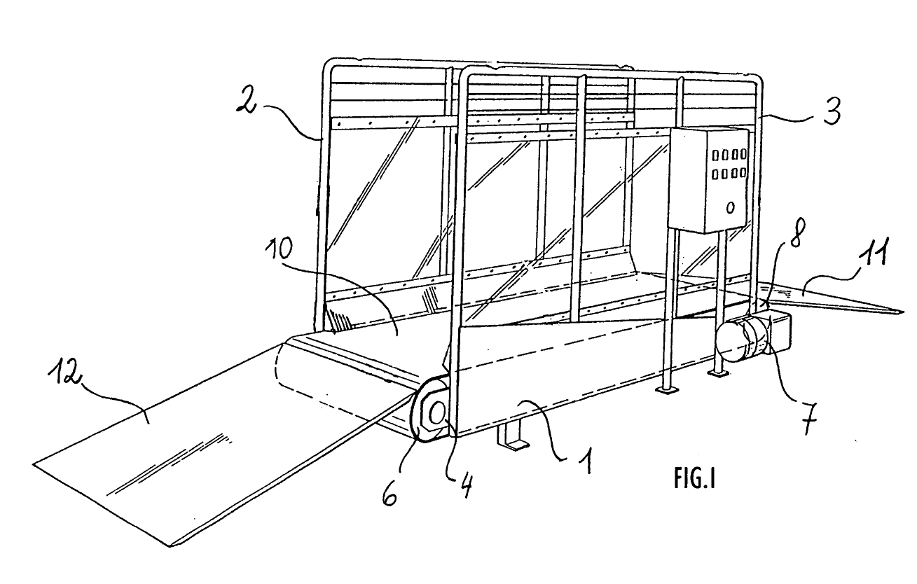

FIG. 1 shows a perspective overall view;

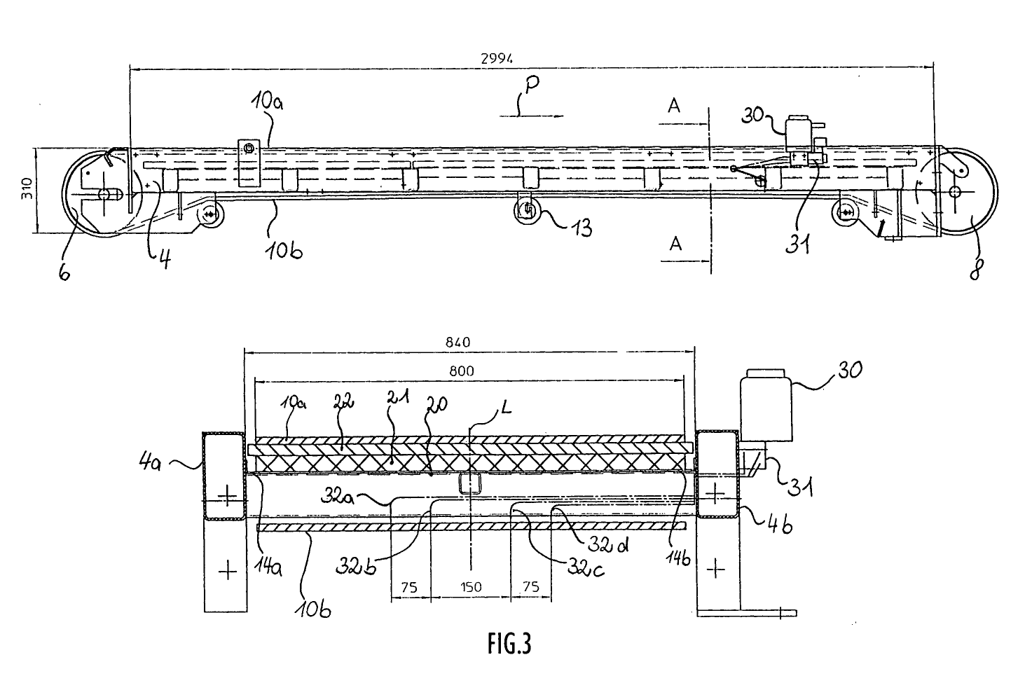

FIG. 2 shows a side view of merely the frame, including the support covering and the belt;

FIG. 3 shows a sectional view along the line A-A in FIG. 2.

The treadmill shown in FIG. 1 comprises a basic structure 1 with side walls 2 and 3. The basic structure 1 holds a frame 4 which comprises at its front end a free-running deflection roller 6 and at its rear end a deflection roller 8 driven via a motor 7. An endless belt 10 runs over the rollers 6 and 8. A ramp 11 is used to guide a horse onto the belt and can be led down from the belt via a ramp 12.

According to FIG. 2, the belt has an upper strand 10a and a lower strand 10b. The lower strand is guided between the deflection rollers 6 and 8 on three small supporting rollers 13.

The cross section along line A-A in FIG. 2, which is shown in FIG. 3 on an enlarged scale, shows that the frame 4 substantially consists of two mutually spaced longitudinal beams 4a and 4b made of a hollow rectangular profile each. L-profiles as supports 14a and 14b are fastened to the inner side of each of the longitudinal beams 4a and 4b. A three-ply support covering rests in a floating manner on the supports, which covering comprises from top to bottom a sheet steel plate 20, a damping plate 21 preferably on the basis of rubber granulate having a honeycomb structure for example, and a preferably antistatic sliding plate 22 made of PTFE, PE or PA. The upper strand 10a of the belt rests on the sliding plate 22. A lubricant container 30 is fastened to the right longitudinal beam which is also shown in FIG. 2 and which is equipped with a conventional filling level monitoring system (not shown) and to which is attached at the bottom an electrically driven dosing pump 31. The dosing pump comprises four dosing cylinders with commonly driven dosing pistons (not shown). A lubricant line branches off of each dosing cylinder. The four lubricant lines 32a to 32d are shown in dot-dash lines. Each of them ends at a short distance above the lower strand 10b of the belt. The respective openings are situated symmetrical to the indicated longitudinal central plane L of the belt, with the openings of the lubricant lines 32a and 32d situated furthest outside from the longitudinal central plane L having a smaller distance than from the adjacent side edge of the belt or its lower strand 10b. Relating to the distance of the deflection rollers 6 and 8, the openings of the lubricant lines 32a to 32d are situated in the region of the running direction of the belt as indicated by the arrow P in FIG. 2 in the region of its last quarter.

1. A treadmill for horses, comprising:
basic structure in which a frame is held which comprises two parallel longitudinal beams which are spaced from one another by more than the width of a horse and which comprises rests for an at least three-ply, continuous support covering, which from top to bottom comprises a sheet steel plate, a damping plate and a sliding plate on which runs the upper strand of an endless belt which is guided via a motively driven deflection roller at the one end of the frame and a freely rotating deflection roller at the other end of the frame, wherein at least one lubricant line each opens on either side of the longitudinal central line of the belt above the lower strand of the belt.

2. A treadmill according to claim 1, wherein two lubricant lines each open on either side of the central line of the belt.

3. A treadmill according to claim 1, wherein the openings of the lubricant lines have a distance of less than a quarter of the width of the belt from the longitudinal central line of the belt.

4. A treadmill according to claim 1, wherein the lubricant lines are connected to a common lubricant container.

5. A treadmill according to claim 4, wherein a dosing pump is arranged between the lubricant container and the lubricant lines.

6. A treadmill according to claim 4, wherein the lubricant container is equipped with an alarm sensor which responds to the lubricant level dropping below a minimal filling level.

7. A treadmill according to claim 5, wherein the dosing pump periodically meters approximately one drop of lubricant onto the lower strand of the belt per dosing stroke and lubricant line.

8. A treadmill according to claim 5, wherein the dosing pump periodically performs one dosing stroke for each lubricant line to adjustable in an interval of between 45 and 120 seconds during the running time of the belt.

9. A treadmill according to claim 1, wherein the lubricant is a high-temperature-resistant silicone oil or silicone grease.

10. A treadmill according to claims 1, wherein at least one of the deflection rollers has a crowned profile.

11. A treadmill according to claim 1, wherein the lubricant lines open at a distance from the front deflection roller which is at least equal to half the distance of the deflection rollers.

12. A treadmill according to claim 1, wherein at least the damping plate and the sliding plate of the support covering rest in a floating manner on the supports.
